(19) United States
(12) Patent Application Publication
(10) Pub. No.: US 2011/0256431 A1
(43) Pub. Date: Oct. 20, 2011

(54) BATTERY TEMPERATURE CONTROL

(75) Inventors: Broc William TenHouten, Los Angeles, CA (US); Philippe Hart Gow, Santa Monica, CA (US)

(73) Assignee: Coda Automotive, Inc., Santa Monica, CA (US)

(21) Appl. No.: 13/084,715

(22) Filed: Apr. 12, 2011

Related U.S. Application Data
(60) Provisional application No. 61/325,063, filed on Apr. 16, 2010.

(51) Int. Cl. H01M 10/50

(52) U.S. Cl. 429/50; 429/120

(57) ABSTRACT

Systems and methods are provided for controlling battery temperature, for example those used in electric vehicles.

### RELATED APPLICATIONS

This application claims priority under 35 U.S.C. §119(e) to U.S. Provisional Patent Application No. 61/325,063, filed Apr. 16, 2010, and entitled “Battery Temperature Control,” which is incorporated herein by reference in its entirety for all purposes.

### FIELD OF INVENTION

Systems and methods related to controlling battery temperature are generally described.

### BACKGROUND

Batteries can be used to provide power to a wide variety of devices, from portable consumer electronics to electric motor vehicles. In many cases, batteries can exhibit reduced performance when they are operated outside a predetermined range of temperatures. For example, when some batteries are too hot, undesirable chemical reactions can occur and/or components of the battery can be structurally compromised, both of which can damage the battery. In some cases, when the battery temperature is too cold, power output can be diminished and, at sufficiently low temperatures, batteries will not charge or discharge. Moreover, thermal gradients within a battery and/or from one battery to another within a pack of batteries can lead to unpredictable power output, among other adverse effects. For these reasons, among others, the ability to control the temperature of batteries is desirable.

### SUMMARY OF THE INVENTION

The embodiments described herein generally relate to systems and methods for controlling battery temperature. The subject matter of the present invention involves, in some cases, interrelated products, alternative solutions to a particular problem, and/or a plurality of different uses of one or more systems and/or articles.

In one aspect, a system for controlling temperature within a battery pack is described. In some embodiments, the system can comprise a battery pack comprising at least one electrochemically rechargeable battery cell; a source of temperature control gas; and a temperature control gas distribution and heat transfer system. In some cases, the temperature control gas distribution and heat transfer system can comprise at least one gas delivery section delivering temperature control gas to the battery pack, and downstream from the gas delivery section, at least one heat exchange section substantially parallel to a surface of the battery pack and having a direction of flow, wherein the heat exchange section passes only across a portion of the pack that is shorter than the dimension of the pack as measured in a direction substantially parallel to the direction of flow of the heat exchange section.

The system can comprise, in some embodiments, a battery pack comprising at least one electrochemically rechargeable battery cell; a source of temperature control gas; and a temperature control gas distribution and heat transfer system constructed and arranged such that at least a portion of the temperature control gas is not transported from one boundary of the battery pack to an opposed boundary of the battery pack.

In some instances, the system can comprise a battery pack comprising electrochemically rechargeable battery cells; a source of temperature control gas; and a temperature control gas distribution and heat transfer system comprising a flow path comprising a first portion that is directed at a first boundary portion of the battery pack and is deflected proximate the first boundary portion such that the flow path changes direction, the battery pack lying within the reflex angle defined by the direction of the flow path, and a second portion that is deflected proximate a second boundary portion of the battery pack such that the flow path changes direction and enters the battery pack through the second boundary portion.

The system can comprise, in some cases, a battery pack comprising electrochemically rechargeable battery cells; a source of temperature control gas; and a temperature control gas distribution and heat transfer system comprising a flow path comprising a first portion that is deflected proximate a boundary of the battery pack such that the flow path changes direction and enters the volume of the battery pack through the boundary, and a second portion that is deflected within the battery pack such that the flow path changes direction.

In another aspect, a method of controlling temperature within a battery pack is described. In some embodiments, the method can comprise establishing the flow of a temperature control gas across at least a portion of a surface of a battery pack, wherein at least a portion of the temperature control gas is not transported from one boundary of the battery pack to an opposed boundary of the battery pack.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B include schematic illustrations of a system including a battery pack comprising a plurality of electrochemically rechargeable battery cells and a temperature control gas distribution and heat transfer system, according to one set of embodiments;

FIG. 2 includes, according to some embodiments, a schematic illustration of a temperature control gas distribution and heat transfer system for a battery pack comprising a plurality of electrochemically rechargeable battery cells; and

FIGS. 3A-3B include schematic illustrations of a system including a battery pack including a single electrochemically rechargeable battery cell and a temperature control gas distribution and heat transfer system, according to one set of embodiments.

### DETAILED DESCRIPTION

Systems and methods are provided for controlling battery temperature, for example those used in electric vehicles. In some embodiments, a temperature control gas is used to heat or cool a battery pack to establish and/or maintain a relatively uniform temperature distribution within the pack. The temperature control gas can also be used to adjust and/or maintain the temperature of the battery pack such that it falls within a pre-selected range of temperatures. In some cases, the temperature control gas can be transported through a temperature control gas distribution and heat transfer system including a gas pathway constructed and arranged such that the temperature control gas exchanges heat with the battery pack only over a portion of the cross-sectional length of the pack. The use of relatively short gas pathways can ensure that the temperature control gas is not heated or cooled to an extent that renders the gas ineffective as a heat exchange medium prior to reaching downstream portions of the battery pack.

Many traditional temperature control systems for batteries have operated by transporting a temperature control gas from one boundary of the battery pack to an opposed boundary of the battery pack. This can lead to relatively large thermal gradients within the battery pack. Briefly, when a temperature control gas is used to control battery pack temperature, the temperature of the gas changes as the gas exchanges heat with the battery pack. For example, when a cooling gas is transported along a battery pack, the cooling gas becomes hotter as it travels along a surface of the battery pack. As the temperature control gas is transported along the pack, the temperature difference between the pack and the gas becomes smaller, relative to the temperature difference between the pack and the gas at the gas inlet. In such cases, more heat can be transferred from the portion of the battery pack near the temperature control gas entry (where a relatively large thermal gradient exists) than can be transferred toward the end of the temperature control gas pathway (where a relatively small thermal gradient exists). This effect can produce an uneven temperature distribution within the battery pack.

The inventors have discovered, within the context of the invention, that the temperature within a battery pack can be more effectively controlled by manipulating the flow pathway of the temperature control gas such that it spans relatively short lengths. In some embodiments, the systems and methods described herein can employ temperature control gas distribution and heat transfer systems including gas pathways that lead to reduced temperature gradients (and hence, reduced disparities in heat flux across the surfaces of the batteries) within the battery pack. For example, in some cases, the temperature control gas distribution and heat transfer system can be constructed and arranged such that at least a portion of the temperature control gas is not transported from one boundary of the battery pack to an opposed boundary of the battery pack.

The systems and methods described herein can be used to control the temperature of battery packs in a wide variety of applications. For example, the temperature of a battery pack of an electric motor vehicle (e.g., to power the drive train and/or electronics systems) can be controlled, in some embodiments. In some cases, the temperature of a battery pack in a portable electronic device (e.g., laptops, cellular phones, and the like) can be controlled. In some cases, the temperature of a battery pack in a stationary energy power storage application (e.g., utility power storage, windmill storage packs, and the like) can be controlled.

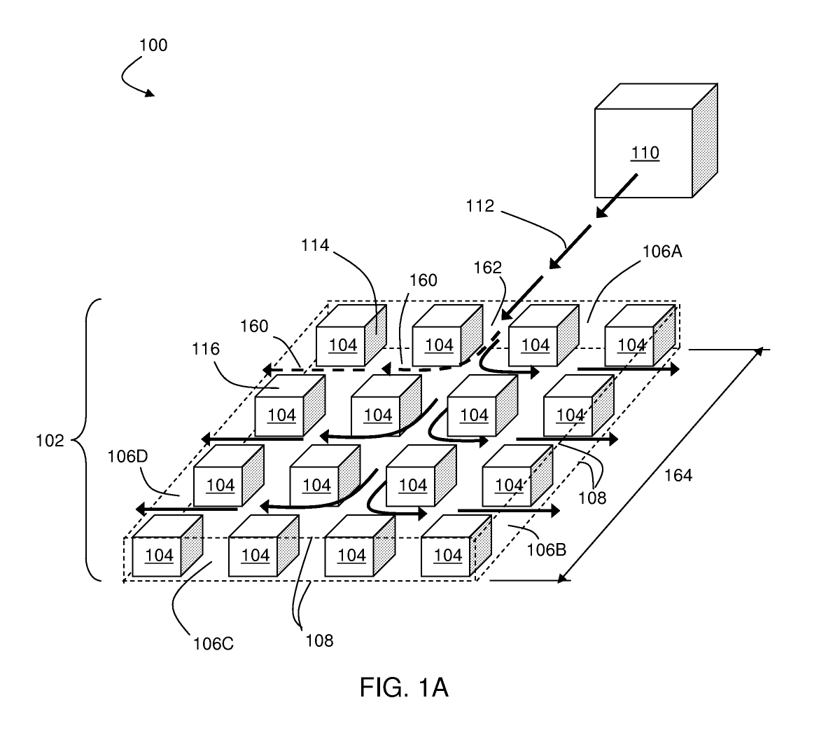

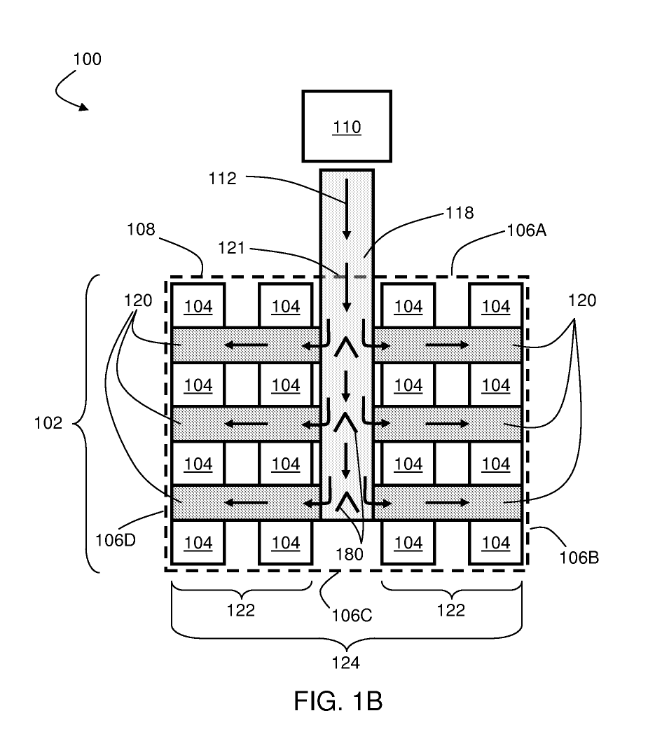

FIGS. 1A-1B include exemplary schematic diagrams illustrating a system 100 including a battery pack and a temperature control gas distribution and heat transfer system, according to one set of embodiments. FIG. 1A includes a perspective view of system 100, while FIG. 1B includes a top-down view of system 100. System 100 includes battery pack 102 containing electrochemically rechargeable battery cells 104. The term “battery pack,” as used herein, is used to refer to a unit that includes at least one electrochemically rechargeable battery cell (e.g., a rechargeable battery cell, a non-rechargeable battery cell, etc.). In the set of embodiments illustrated in FIGS. 1A-1B, the battery pack includes a plurality of electrochemically rechargeable battery cells. In other embodiments, the battery pack can contain a single electrochemically rechargeable battery cell. The boundaries of a battery pack are defined by imaginary surfaces extending across the outermost boundaries of the peripheral cells within the pack. I.e., the battery pack boundaries encase all cells, but do not extend therebeyond (with the exception of, e.g., a slight extension beyond the outermost boundaries of the peripheral cells to accommodate a flow space, advantageous cell-encasing material, etc.; those of ordinary skill in the art will understand the meaning of battery pack in this context. In FIGS. 1A-1B, battery pack 102 includes boundaries 106A-D, the surfaces of which are defined by dotted lines 108.

As mentioned, temperature control can be achieved using a temperature control gas. As used herein, a “temperature control gas” refers to a gas that is used to exchange heat with a component of the battery pack to alter the temperature of the component. In some embodiments, the temperature control gas can act as a cooling gas by removing heat from a portion of a battery pack component. The temperature control gas can act as a heating gas, in some cases, by supplying heat to a portion of a component of the battery pack. The temperature control gas can be used to maintain a substantially consistent temperature throughout the battery pack and/or to ensure that the minimum and maximum temperatures of the battery pack lie within a predetermined temperature range.

In FIGS. 1A-1B, temperature control gas source 110 is used to provide temperature control gas 112 to battery pack 102. Any suitable source can be used to supply temperature control gas to the battery pack. In some embodiments, the source is located outside the device powered by the battery pack. For example, the temperature control gas can comprise ambient air transported to the battery pack via an air intake system. In some cases, the source of temperature control gas can be located inside the device powered by the battery pack. For example, the source might be a compressed air cylinder. In some cases, the source can be a climate control system (e.g., air conditioner and/or heater) within an automobile. In some embodiments, the source can include a recirculation system in which gas is recirculated within the battery pack. Recirculation of gas within the battery pack can be beneficial because it can obviate the need to dehumidify and/or alter the temperature of air from outside the battery pack.

System 100 can also include a temperature control gas distribution and heat transfer system. The temperature control gas distribution and heat transfer system can be constructed and arranged to establish the flow of the temperature control gas across at least a portion of a surface of the battery pack. As the temperature control gas is transported across the portion of the surface of the battery pack, it can exchange heat with the battery pack such that the portion of the battery pack surface that is contacted is heated or cooled. In some embodiments, the temperature control gas can be transported across an interior surface within the battery pack. For example, the temperature control gas can be used to heat or cool an exterior surface of a battery cell that lies within the boundaries of the battery pack, such as surface 114 in FIG. 1A. In some instances, the temperature control gas can be used to heat or cool an exterior surface of the battery pack, such as surface 116 in FIG. 1A.

In some embodiments, the temperature control gas distribution and heat transfer system can include at least one gas delivery section that can be used to deliver temperature control gas to the battery pack. As shown in FIG. 1B, which includes a top-view schematic diagram of system 100 illustrated in FIG. 1A, system 100 includes gas delivery section 118 that is used to transport temperature control gas from source 110 to battery pack 102. In some embodiments, the gas delivery section can extend into the battery pack. Generally, the gas delivery section includes a portion both external to the battery pack, and a portion internal to the battery pack, but this need not be the case in all embodiments. E.g., the gas delivery section may be completely external to the battery pack, completely internal to the pack, or a combination. The gas delivery section typically includes a portion of the fluidic pathway within the battery pack that is in direct fluidic communication with a temperature control gas entry, and in which the temperature control gas is transported in a direction substantially parallel to the direction of flow upon entry into the pack. The term “fluid communication,” as used herein, refers to two volumes constructed and arranged such that a fluid can flow between them. In some cases, the first and second volumes can be in direct fluid communication. As used herein, two devices are in “direct fluid communication” when the fluidic connection between the two articles is uninterrupted by the presence of additional devices.

In FIG. 1B, the temperature control gas enters battery pack 102 at boundary portion 121. In this set of embodiments, the gas delivery section 118 includes the portions of the fluidic pathways within battery pack 102 that extend from boundary portion 121 in a direction substantially parallel to the direction of the gas flow at boundary 121 (indicated by the vertical arrows in FIG. 1B). While FIG. 1B includes a single gas delivery section, it should be understood that, in some embodiments, multiple gas delivery sections can be employed.

The temperature control gas distribution and heat transfer system can also include, in some embodiments, at least one heat exchange section downstream from the gas delivery section. In some embodiments, the gas delivery section can be constructed and arranged to deliver temperature control gas to the heat exchange section(s), where the gas can be used to exchange heat with the battery cells in the battery pack. A heat exchange section can, in some embodiments, comprise a branch (e.g., a channel or other suitable fluid passageway) fluidically connected to, and extending from the gas delivery section. In some embodiments, multiple heat exchanges sections can extend from the gas delivery section. For example, in FIG. 1B, gas delivery section 118 extends into the battery pack and delivers temperature control gas to heat exchange sections 120. As shown in FIG. 1B, heat exchange sections 120 are substantially parallel to multiple battery cell surfaces within the battery pack.

In some embodiments, the heat exchange section(s) within the battery pack can be relatively short. In some embodiments, one or more heat exchange sections pass only across a portion of the battery pack that is shorter than the dimension of the pack as measured in a direction substantially parallel to the direction of flow of the heat exchange section. For example, in FIG. 1B, heat exchange sections 120 pass only across portion 122 of battery pack 102. However, the dimension of the pack, as measured in a direction substantially parallel to the direction of flow of the heat exchange section, is indicated by dimension 124, which is substantially longer than the length of portion 122. Generally, the dimension of a battery pack, as measured in a direction substantially parallel to the direction of flow of a heat exchange section, is measured as the distance between the boundaries of the battery pack that intersect a vector drawn along the average direction of flow within the heat exchange section. This may be equated with a characteristic dimension of the pack as that term is typically used by those of ordinary skill in the art. In some embodiments, at least one heat exchange section passes only across a portion of the pack with a length substantially equal to or less than about 50%, substantially equal to or less than about 25%, or substantially equal to or less than about 10% of the dimension of the battery pack as measured in a direction substantially parallel to the direction of flow of the heat exchange section.

The use of short heat exchange sections can ensure that the surface area over which the temperature control gas contacts the surface(s) of the battery cells is relatively small. When the area of contact between the temperature control gas and the battery cells is relatively small, it is relatively easy to ensure that the temperature control gas is not excessively heated or cooled as it is transported through the system, compared to systems in which large contact areas are employed. Relatively short contact areas can allow for effective heat transfer while using relatively low temperature control gas flow rates and/or relatively small temperature differences between the temperature control gas and the battery cells.

In some embodiments, the gas delivery section(s) and heat exchange section(s) can be constructed and arranged such that relatively little heat transfer occurs in the gas delivery section(s) and a relatively large amount of heat transfer occurs in the heat exchange section(s). For example, in some embodiments, at least about 75%, at least about 90%, at least about 95%, or at least about 99% of the heat transferred between the temperature control gas and the cells within the battery pack is transferred within heat exchange sections of the temperature control gas distribution and heat transfer system within the battery pack. One of ordinary skill in the art would be capable of determining the amount of heat transferred within various parts of the passageways within the battery pack by, for example, measuring the temperature of the gas within the battery pack at various positions within the temperature control gas distribution and heat transfer system and on the surfaces of the cells, and calculating the amount of heat transferred based upon the enthalpy of the temperature control gas.

In some embodiments, at least a portion of the temperature control gas is not transported from one boundary of the battery pack to an opposed boundary of the battery pack. Temperature control gas is said to be transported from one boundary of a battery pack to an opposed boundary of the battery pack when it enters the pack through a first boundary and exits the pack through a second, opposed boundary. In FIG. 1B, a portion of the temperature control gas that is transported through the boundary pack enters the battery pack through boundary 106A and exits through 106D, which is not opposed to boundary 106A (in contrast to boundary 106C, which is opposed to boundary 106A). Similarly, a portion of the temperature control gas is transported into the pack through boundary 106A and out of the pack through boundary 106B, which also is not opposed to boundary 106A. Generally, two boundaries are opposed to each other if they are substantially parallel in relation to each other. For example, in FIG. 1B, boundaries 106A and 106C are opposed to each other. Similarly, boundaries 106B and 106D are opposed to each other. It should be understood that boundaries need not be exactly parallel to each other to be opposed, and that, in some cases, the boundaries can be slightly angled in relation to each other (e.g., 5° or less, 3° or less, or 1° or less) and still be considered to be opposed to each other.

The temperature control gas can be, in some embodiments, transported over a relatively short length. In some instances, at least a portion of the temperature control gas is transported along a length that is substantially equal to or less than about 75%, substantially equal to or less than about 50%, substantially equal to or less than about 25%, or substantially equal to or less than about 10% of the dimension of the pack as measured in a direction substantially parallel to the direction of flow of the temperature control gas at the temperature control gas inlet. For example, in FIG. 1A, a portion of the temperature control gas (indicated by dashed arrows 160) is transported a relatively short distance, as measured along dashed arrows 160. In contrast, the dimension of the battery pack as measured in a direction substantially parallel to the direction of flow of the temperature control gas at inlet region 162 is indicated as dimension 164, which is more than 1.5 times longer than the distance along dashed arrows 160 according to the embodiment illustrated. Generally, the dimension of a battery pack, as measured in a direction substantially parallel to the direction of flow at the temperature control gas inlet is measured as the distance between the boundaries of the battery pack that intersect a vector drawn along the direction of flow at the inlet. In addition, the length along which a temperature control gas is transported is measured along the path traversed by the gas.

In some cases, a relatively large portion of the temperature control gas that is transported through the boundary pack is not transported from one boundary of the battery pack to an opposed boundary of the battery pack. For example, in some instances, at least about 50%, at least about 75%, at least about 90%, at least about 95%, at least about 99%, or substantially all of the temperature control gas that is transported through the battery pack is not transported from one boundary of the battery pack to an opposed boundary of the battery pack. In FIGS. 1A-1B, for example, substantially all of the temperature control gas is transported into the battery pack through boundary 106A, and out of the battery pack through non-opposed boundaries 106B and 106D. Transport between non-opposed boundaries can be achieved using pathways that include at least one turn within the battery pack. In some cases, at least a portion of the temperature control gas (e.g., at least about 50%, at least about 75%, at least about 90%, at least about 95%, at least about 99%, or substantially all) is transported along a pathway within the battery pack that includes at least one turn. The temperature control gas pathway within the battery pack can include, in some cases, at least one turn of at least about 15°, at least about 30°, at least about 45°, at least about 60°, at least about 75°, at least about 90°, between about 15° and about 115°, between about 30° and about 115°, or between about 45° and about 115°. For example, the temperature control gas pathways illustrated in FIGS. 1A-1B include turns of about 90° between the gas delivery section 118 and the heat exchange sections 120. In some embodiments, the turn within the temperature control gas pathway can be achieved via the use of one or more fins, the use of which can reduce eddy formation within the flow path, as described below.

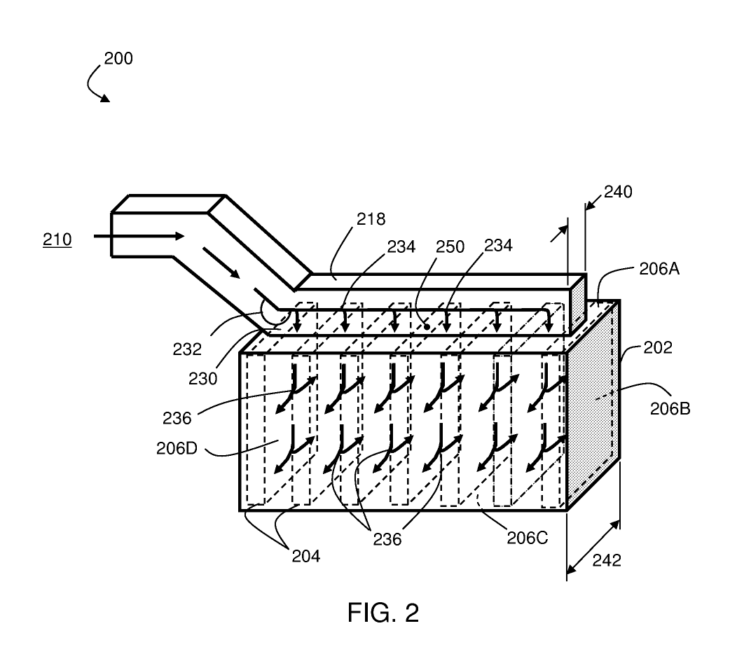

In some cases, the temperature control gas distribution and heat transfer system can include a flow path comprising multiple turns. FIG. 2 includes a schematic illustration of system 200 that includes multiple turns. In FIG. 2, battery pack 202 includes electrochemically rechargeable battery cells 204 (illustrated in dotted lines to maintain clarity). Temperature control gas is delivered to the battery pack from source 210 via gas delivery section 218.

In some embodiments, the temperature control gas distribution and heat transfer system includes a flow path comprising a first portion that is directed at a first boundary portion of the battery pack and is deflected proximate the first boundary portion such that the flow path changes direction. In such cases, the battery pack can lie within the reflex angle defined by the direction of the flow path. For example, in the set of embodiments illustrated in FIG. 2, the gas delivery section 218 includes a flow path in which the temperature control gas is deflected proximate first boundary portion 230 of top boundary 206A. The deflection can be facilitated, in some embodiments, by a fin, baffle, or other suitable surface arranged external to and proximate the battery pack. For example, in the set of embodiments shown in FIG. 2, a fin (which is not illustrated to maintain clarity) can be positioned proximate boundary portion 230 to deflect the gas as it approaches battery pack 202. In FIG. 2, battery pack 202 lies within reflex angle 232 defined by the deflection of the temperature control gas stream. The flow path can be deflected at any suitable angle. In some embodiments, the reflex angle (in which the battery pack lies) defined by the deflection of the temperature control gas stream can be at least about 200°, at least about 230°, at least about 250°, between about 200° and about 270°, or between about 230° and about 270°.

The flow path of the temperature control gas can include, in some instances, a portion in which the temperature control gas is deflected proximate a boundary portion of the battery pack such that the flow path changes direction and enters the battery pack through the boundary portion. For example, in FIG. 2, battery pack 202 includes multiple boundary portions 234 of top boundary 206A, proximate which the temperature control gas is deflected such that it enters the battery pack. The arrangement outlined in FIG. 2 provides multiple temperature control gas entry points, which can allow for more uniform temperature control within the battery pack. While the set of embodiments illustrated in FIG. 2 includes entry points constructed and arranged such that the temperature control gas enters at a substantially perpendicular angle with respect to top boundary 206A, any other suitable entry angles can be employed in other embodiments.

The temperature control gas flow path can also include, in some embodiments, one or more portions within the battery pack at which the temperature control gas changes direction. For example, in FIG. 2, the flow path includes multiple regions 236 at which the temperature control gas changes direction from being transported toward lower boundary 206C to rear and front boundaries 206B and 206D, respectively. While the set of embodiments illustrated in FIG. 2 includes 90° changes in direction within the battery pack, the flow path can be constructed and arranged to produce any suitable change in direction. In the set of embodiments illustrated in FIG. 2, substantially none of the temperature control gas is transported from top boundary 206A to opposed, bottom boundary 206C, and substantially all of the temperature control gas exits rear and front boundaries 206B and 206D, respectively.

The temperature control gas can, in some cases, be transported into the battery pack through a relatively small portion of a battery pack boundary. For example, in some cases, substantially all of the temperature control gas can be transported into the battery pack through a portion (or multiple portions) of a battery pack boundary that occupies less than about 50%, less than about 25%, less than about 10%, or less than about 5% of the surface area of the battery pack boundary. As a specific example, in the set of embodiments illustrated in FIG. 2, substantially all of the temperature control gas is transported into battery pack 202 through a portion of top boundary 206A that occupies only about 25% of the surface area of top boundary 206A. In some cases, substantially all of the temperature control gas can be transported through a portion of a battery pack boundary including at least one dimension that is substantially smaller (e.g., less than about 50% of, less than about 25% of, less than about 10% or, or less than about 5% of) the corresponding dimension of that boundary. For example, in FIG. 2, the portion of top boundary 206A through which the gas is transported has a depth 240 that spans only about 25% of the depth 242 of top boundary 206A.

In some cases, the portion of the boundary of the battery pack through which the temperature control gas enters the battery pack can include the geometric center of the boundary. Transporting the temperature control gas through the geometric center of a battery pack boundary can provide for a substantially even distribution of temperature control gas within the battery pack, which can lead to uniform and more controllable heat transfer, in some cases. In some instances, the geometric centers of the portion through which the gas enters and the boundary in which the entry portion is located are substantially aligned (i.e., the portion of the boundary through which the temperature control gas enters is centered on the geometric center of that boundary). For example, in the set of embodiments illustrated in FIG. 2, the geometric center of top boundary 206A and the geometric center of the portion of top boundary 206A through which the temperature control gas enters the battery pack both lie on point 250. In some embodiments, the portion of the boundary of the battery pack through which the temperature control gas enters the battery pack can be substantially evenly distributed around the geometric center of the boundary.

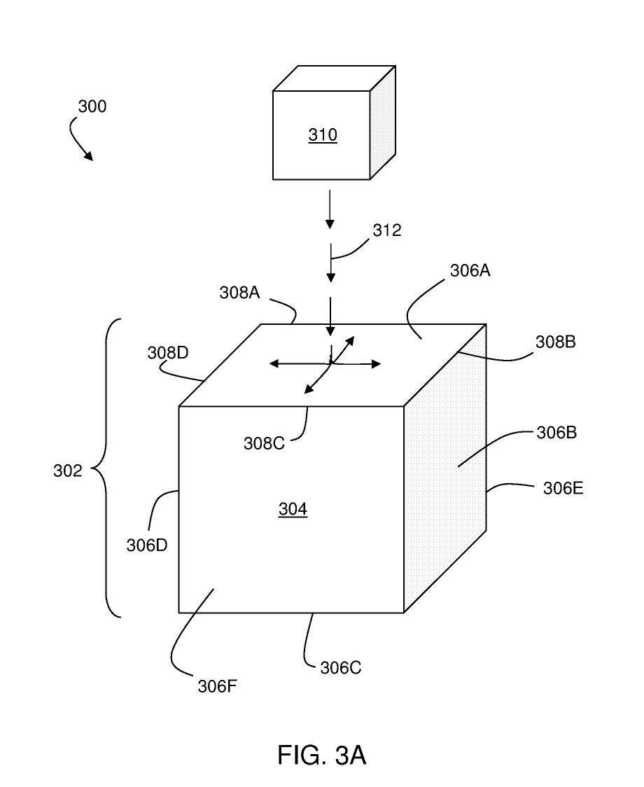

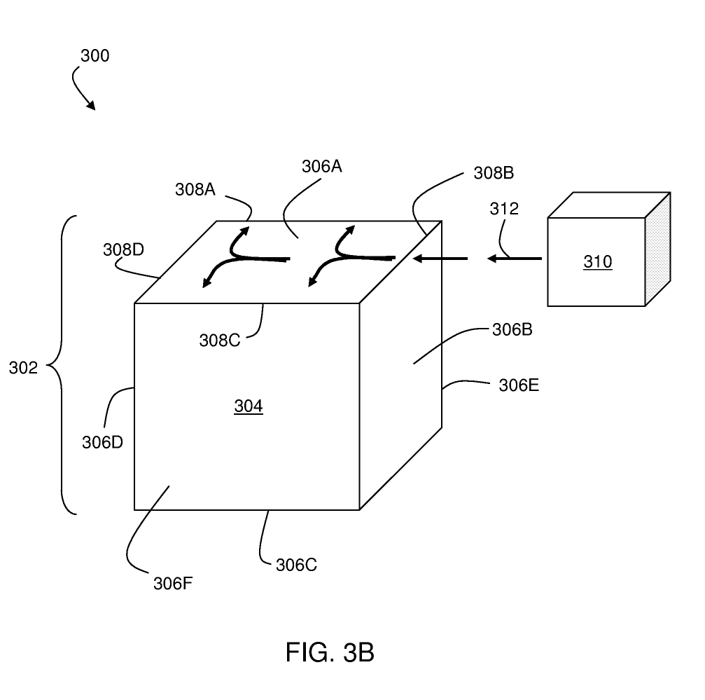

While embodiments have been described in which the battery pack includes a plurality of electrochemically rechargeable battery cells, other embodiments might make use of a battery pack that includes a single electrochemically rechargeable battery cell. For example, in the set of embodiments illustrated in FIG. 3A, system 300 includes battery pack 302, which includes a single battery cell 304. In this set of embodiments, temperature control gas 312 is transported from source 310 to top boundary 306A of the battery pack. The temperature control gas pathway is constructed and arranged such that the temperature control gas contacts top boundary 306A near its geometric center, and is subsequently transported to edges 308A-D. In FIG. 3A, substantially none of the temperature control gas is transported from one boundary of the battery pack to an opposed boundary of the battery pack. In some embodiments, additional pathways can be constructed and arranged such that temperature control gas is transported to (e.g., near the geometric center of) right-side boundary 306B, bottom boundary 306C, left-side boundary 306D, rear boundary 306E, and/or front boundary 306F.

FIG. 3B includes a schematic illustration of another set of embodiments in which the battery pack includes a single electrochemically rechargeable battery cell. In this set of embodiments, temperature control gas 312 is transported from source 310 to edge 308B of top boundary 306A of the battery cell 304. The temperature control gas pathway is constructed and arranged such that the temperature control gas contacts top boundary 306A, and is subsequently redirected toward edges 308A and 308C. In FIG. 3B, substantially none of the temperature control gas is transported from boundary 306B (via edge 308B) to opposed boundary 306D (via edge 308D). In some embodiments, additional pathways can be constructed and arranged such that temperature control gas is transported across right-side boundary 306B, bottom boundary 306C, left-side boundary 306D, rear boundary 306E, and/or front boundary 306F.

In the systems and methods described herein, the flow of temperature control gas can be established using any suitable method. In some cases, the temperature control gas can be transported using a pump and/or a vacuum. In some cases, the temperature control gas can be transported relative to the battery pack due to the movement of the battery pack relative to the temperature control gas. For example, in some cases, the temperature control gas can comprise ambient air that is transported through an air intake manifold upon movement of an automobile.

The temperature control gas distribution and heat transfer system can include, in some embodiments, one or more channels (e.g., from the temperature control gas source to the battery pack, between battery cells in the battery pack, etc.). A “channel,” as used herein, refers to a feature on or in an article or substrate, or between two articles, that at least partially directs the flow of a fluid. A channel can have any cross-sectional shape (circular, semi-circular, oval, semi-oval, triangular, irregular, square or rectangular, or the like) and can be covered or uncovered. In embodiments where it is completely covered, at least one portion of the channel can have a cross-section that is completely enclosed, or the entire channel can be completely enclosed along its entire length with the exception of its inlet(s) and outlet(s). A channel can also have an aspect ratio (length to average cross sectional dimension) of at least 2:1, more typically at least 3:1, 5:1, or 10:1 or more.

The direction of fluid flow within a temperature control gas flow pathway can be controlled using any suitable device. In some embodiments, the surfaces of the batteries within the battery pack can be arranged to obtain the desired flow profile. In some cases, the flow profile can be controlled using one or more fins within the system (e.g., within the battery pack). For example, FIG. 1B includes a plurality of optional fins 180 (which are not illustrated in FIG. 1A for purposes of clarity), which can redirect a portion of the flow of gas from gas delivery section 118 to heat exchange sections 120. In addition to controlling the flow of gas within the system, the use of fins can reduce small-scale recirculation (e.g., eddy formation) within the flow path, thus producing a more predictable flow through the battery pack. As another example, one or more fins could be positioned within gas delivery section 218 of system 200, illustrated in FIG. 2, for example, to redirect the flow of temperature control gas between cells within the battery pack. In some embodiments, a plurality of fins can be employed, each fin having the same length and/or width. In other cases, the plurality of fins can be of two or more sizes (e.g., lengths, cross-sectional widths, etc.).

U.S. Provisional Patent Application No. 61/325,063, filed Apr. 16, 2010, and entitled “Battery Temperature Control” is incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system for controlling temperature within a battery pack, comprising:
a battery pack comprising at least one electrochemically rechargeable battery cell;
a source of temperature control gas; and
a temperature control gas distribution and heat transfer system comprising:
at least one gas delivery section delivering temperature control gas to the battery pack, and
downstream from the gas delivery section, at least one heat exchange section substantially parallel to a surface of the battery pack and having a direction of flow, wherein the heat exchange section passes only across a portion of the pack that is shorter than the dimension of the pack as measured in a direction substantially parallel to the direction of flow of the heat exchange section.

2. A system as in claim 1, wherein the heat exchange section passes only across a portion of the pack with a length substantially equal to or less than about 50% of the dimension of the pack as measured in a direction substantially parallel to the direction of flow of the heat exchange section.

3. A system for controlling temperature within a battery pack, comprising:
a battery pack comprising at least one electrochemically rechargeable battery cell;
a source of temperature control gas; and
a temperature control gas distribution and heat transfer system constructed and arranged such that at least a portion of the temperature control gas is not transported from one boundary of the battery pack to an opposed boundary of the battery pack.

4. A system as in claim 3, wherein the temperature control gas distribution and heat transfer system is constructed and arranged such that at least a portion of the temperature control gas is transported along a length that is substantially equal to or less than about 75% of the dimension of the pack as measured in a direction substantially parallel to the direction of flow of the temperature control gas at the temperature control gas inlet.

5. A system as in claim 3, wherein substantially all of the temperature control gas is transported into the battery pack through a portion of a battery pack boundary that occupies less than about 50% of the surface area of the battery pack boundary.

6. A system for controlling temperature within a battery pack, comprising:
a battery pack comprising electrochemically rechargeable battery cells;
a source of temperature control gas; and
a temperature control gas distribution and heat transfer system comprising a flow path comprising:
a first portion that is directed at a first boundary portion of the battery pack and is deflected proximate the first boundary portion such that the flow path changes direction, the battery pack lying within the reflex angle defined by the direction of the flow path, and
a second portion that is deflected proximate a second boundary portion of the battery pack such that the flow path changes direction and enters the battery pack through the second boundary portion.

7. The system of claim 6, wherein the reflex angle is between about 200° and about 270°.

8. A system for controlling a temperature within a battery pack, comprising:
a battery pack comprising electrochemically rechargeable battery cells;
a source of temperature control gas; and
a temperature control gas distribution and heat transfer system comprising a flow path comprising:
a first portion that is deflected proximate a boundary of the battery pack such that the flow path changes direction and enters the volume of the battery pack through the boundary, and
a second portion that is deflected within the battery pack such that the flow path changes direction.

9. A method of controlling temperature within a battery pack, comprising:
establishing the flow of a temperature control gas across at least a portion of a surface of a battery pack, wherein at least a portion of the temperature control gas is not transported from one boundary of the battery pack to an opposed boundary of the battery pack.

10. A method as in claim 9, wherein at least a portion of the temperature control gas is transported along a length that is substantially equal to or less than about 75% of the dimension of the pack as measured in a direction substantially parallel to the direction of flow of the temperature control gas at the temperature control gas inlet.

11. A system as in claim 1, wherein the temperature control gas is used to cool at least a portion of the battery pack.

12. A system as in claim 1, wherein the temperature control gas is used to heat at least a portion of the battery pack.

13. A system as in claim 1, wherein the temperature control gas comprises air.

14. A system as in claim 1, wherein at least about 50% of the temperature control gas that is transported through the battery pack is not transported from one boundary of the battery pack to an opposed boundary of the battery pack.

15. A system as in claim 1, further comprising at least one fin that at least partially directs the flow of fluid within the temperature control gas distribution and heat transfer system.

16. A system as in claim 1, wherein the battery pack is constructed and arranged to power, at least in part, a vehicle.

17. A system as in claim 1, wherein the battery pack is constructed and arranged to power, at least in part, the drive train of a vehicle.

18. A system as in claim 1, wherein the battery pack contains a single electrochemically rechargeable battery cell.

19. A system as in claim 1, wherein the battery pack comprises a plurality of electrochemically rechargeable battery cells.
